(19) United States
(12) Patent Application Publication
(10) Pub. No.: US 2017/0255863 A1
(43) Pub. Date: Sep. 7, 2017

(54) SYSTEM AND METHOD OF NETWORK OPTIMIZATION

(71) Applicant: Supported Intelligence, LLC, East Lansing, MI (US)

(72) Inventors: Patrick L. Anderson, East Lansing, MI (US); Neal P. Anderson, East Lansing, MI (US)

(21) Appl. No.: 15/449,939

(22) Filed: Mar. 4, 2017

Related U.S. Application Data
(60) Provisional application No. 62/303,716, filed on Mar. 4, 2016.

(51) Int. Cl. G06N 5/02; G06N 7/00

(52) U.S. Cl. CPC G06N 5/022; G06N 7/005

(57) ABSTRACT

A system and method for optimizing management of a network by transforming the network into some or all of the elements of a sequential decision problem, then composing a sequential decision problem; error and convergence checking the sequential decision problem; and solving the sequential decision problem. The solution to the sequential decision problem is provided to a user as decision advice or automatically implemented. The network may be a website designed for access by users of mobile or other devices, or a logistics network for the distribution of goods, or a utility network for communications, energy, roads or other services. The decision advice allows the user to optimize the network to improve an aspect of the network, such as the amount of time spent traveling through the network (for roads) or the total-value derived from visitors (for a website selling products).

### CROSS-REFERENCE TO RELATED APPLICATIONS

This application claims priority to U.S. provisional application 62/303,716. This application incorporates by reference U.S. application Ser. Nos. 14/982,382, 13/486,691 and 14/458,209.

### BACKGROUND OF THE INVENTION

Field of the Invention

A “network” is composed of a set of nodes and edges, where the nodes represent states, places, web pages, or other indications of status; and “edges” represent the ability to transition among these nodes. A “directed graph” is a representation of a network, including nodes and edges and where the available direction of transition among those nodes is part of the structure of the network.

The analysis of networks has taken on increasing importance as Internet-based networks (as well as numerous variations and extensions such as websites, “intranets,” social network and similar content-sharing and personal or business introduction applications, and cloud-hosted applications) as well as logistics networks (such as roads and intersections, transportation networks, and networks for distribution of goods or for the transit of people) have become fundamental to the world economy and to the operations of a huge share of organizations ranging from individual families, sets of friends, and small and large businesses and associations.

Description of Related Art

Current systems and methods of analyzing web sites, traffic systems, and other networks suffer from deficiencies, including: viewing the structure of the network as static; failing to consider how users of the network have real options (such as the option to leave the network); failure to recognize that potential costs, rewards, and transition probabilities within the network may be path-dependent; and naive summarization of network characteristics into metrics that do not take into account fundamental characteristics of the users of networks.

Such insufficient methods include: relying on “heat maps” of a handful of individual web pages to visualize network productivity; measuring only the activities forward from one web page, rather than considering the entire network; assuming the cumulative transition probabilities of network users are represented as a simple product of probabilities of a straightforward path through such nodes; lack of consideration of the differing types of network users (where such types can be identified or inferred from their initial entry into the network or other credentials or characteristics); and metrics and advice that rely on the assumption that the structure of the network cannot be changed or that users understand or accept the existing structure.

### SUMMARY OF THE INVENTION

The present invention relates to a system and method for optimizing a network by a computer-aided network control system with an input device, an output device and a processor. The input device allows input of information to the processor, the output device allows output of information from the processor and the network has nodes and edges. The nodes have at least one characteristic and at least one edge. The characteristics represent information about the corresponding node and the edges represent relationships between nodes.

The processor evaluates a decision problem concerning the network to provide decision making advice using information from the input device and the processor using the output device to output the decision making advice. The processor evaluates the decision problem by facilitating input from the input device of information defining the decision problem including: (i) An action set, the action set having elements representing actions relevant to the network, each element in the action set having a corresponding cost. (ii) At least one state dimension, each state dimension having elements representing conditions relevant to the network and each state dimension having a corresponding reward vector representing rewards associated with the corresponding elements of the state dimension.

Furthermore, each state dimension having a corresponding transition matrix representing the probability of moving from each state in the state dimension to each state, for each action in the action set. (iii) A time index and discount factor, the time index containing decision points, each decision point representing a point in time when one of the actions from the action set is performed, and the discount factor representing the preferential weighting of rewards relative to time. (iv) Optionally, elements of the action set representing actions that change at least one of the nodes, edges, state dimensions, reward vectors, transition matrices, the time index or the discount factor.

The processor further combines the reward vectors with the action cost set to form a reward matrix, the transition matrices with the action set to form a total transition matrix and forms a functional equation from the reward matrix, the total transition matrix and the remaining information.

The processor additionally evaluates the functional equation, including error-checking of inputs, validation of inputs, performing an convergence check to ensure the functional equation is solvable and solving the functional equation.

The processor further generates decision making advice concerning the network from the solved functional equation, the decision making advice showing for every point in the decision index the overall value-maximizing action and outputs the decision making advice through the output device. In another embodiment a traffic control system is disclosed with a monitoring device, a control device, a traffic network and a processor. The monitoring device monitors traffic conditions on the traffic network. The traffic network has a plurality of nodes and edges, each node represents entrances to a location in the traffic network, each edge represents the moves between nodes. At least one node has a changeable signal device and the changeable signal device has variable output. The control device allows output of information from the processor is capable of changing the changeable signaling device's output.

The processor evaluates a decision problem concerning the traffic network to provide decision making advice using information from the monitoring device and the processor uses the decision making advice and the control device to control the changeable signaling device. The processor evaluates the decision problem using input from the input device of information defining the decision problem, including: (i) An action set, the action set has elements representing actions relevant to the traffic network and each element in the action set has a corresponding cost, and at least one traffic action set. The traffic action set represents the capabilities of the changeable signaling device's output. (ii) At least one state dimension, each state dimension has elements representing conditions relevant to the traffic network, each state dimension has a corresponding reward vector representing rewards associated with the corresponding elements of the state dimension and each state dimension has a corresponding transition matrix representing the probability of moving from each state in the state dimension to each state, for each action in the action set and at least one state dimension for each node representing the number of visitors at the node. (iii) A time index and discount factor. The time index contains decision points, each decision point represents a point in time when one of the actions from the action set is performed. The discount factor represents the preferential weighting of rewards relative to time. (iv) Actions that change at least one of the nodes, edges, state dimensions, reward vectors, transition matrices, the time index or the discount factor.

The processor combines the reward vectors with the action cost set to form a reward matrix, and the transition matrices with the action set to form a total transition matrix. The processor further forms a functional equation from the reward matrix, the total transition matrix and the remaining information.

The processor further evaluates the functional equation, including error-checking of inputs, validation of inputs, including performance of an convergence check to ensure the functional equation is solvable and then solves the functional equation.

The processor generates decision making advice concerning the network from the solved functional equation, the decision making advice showing for every point in the decision index the overall value-maximizing action.

The processor uses the control device to implement the decision making advice using the output device for at least one decision point in the time index by taking the appropriate action from the action set according to the decision making advice for the relevant decision point in time for the traffic network.

Then the processor receives and stores additional information from the monitoring device as time progresses, additionally the processor re-optimizes the decision making advice using the additional information to modify the information used to form the functional equation, then the processor forms and evaluates the functional equation and generates new decision making advice. Furthermore, the processor implements the new decision making advice using the output device for at least one decision point in the time index by taking the appropriate action from the action set according to the decision making advice for the relevant decision point in time for the network and the processor continues to receive and store additional information and re-optimize and implement the new decision making advice for at least one of the future in time decision points.

### BRIEF DESCRIPTION OF THE DRAWINGS

FIG. 1. is a block diagram showing a computer system capable of controlling a network and capable of optimizing the network based upon received information.

FIG. 2. is a flowchart showing the use network data to create a sequential decision problem for use in network optimization.

FIG. 3. is a flowchart showing an iterated process of network optimization.

FIG. 4. is a diagram and table showing a choose-your-adventure network.

FIG. 5. is a diagram and table showing a graph with nodes, edges and differing throughput between nodes.

FIG. 6. is a diagram showing the evolution across three consecutive decision points of a traffic network being optimized.

### DETAILED DESCRIPTION OF THE INVENTION

Transforming networks into some or all of the elements of a series of sequential decision problems allows a user to increase the overall value of the network system. The value of the network system is based on the current and anticipated benefits of the network, given the operator's ability to control it now and in the future. The benefits to the operator, who may be a manger, a network operator, a business owner or anyone with control over a network or input into the management of a network, can be defined in terms of revenue or profit from visitor activity on the site (such as for a website); throughput or accident-free trips through a traffic or logistics network; or successful routes or other visitor activity through another type of network.

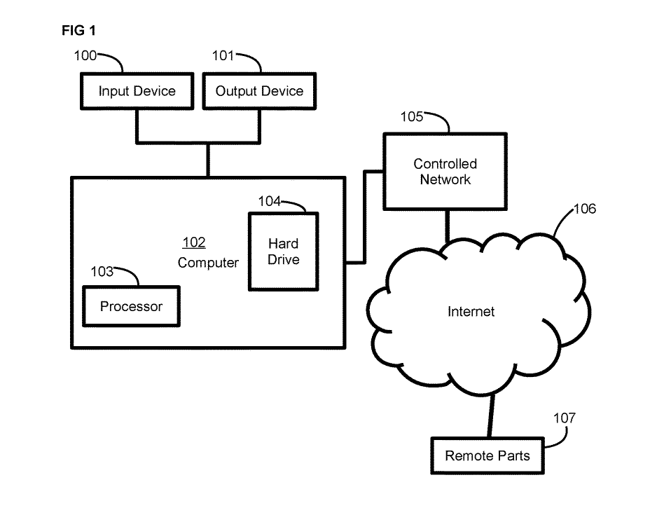

The disclosed system and method may be implemented by a variety of computing systems (FIG. 1). The computing system has a computer 102 with a processor 103, an input device 100, an output device 101, a hard drive 104, a controlled network 105 and is connected to another network (here shown as the Internet 106. Parts of the computer may be located or stored remotely as shown in remote parts 107. The computer 102 is capable of executing computer software (not shown) that programs the computer to receive information on a network, compose a sequential decision problem or set of sequential decision problems (optionally transforming the network information into directed graphs), validate the problem(s) by performing convergence and error checks, solve the problem(s), and output the resulting solution(s) to the user. The computer 102 may be a personal computer, laptop, desktop, smart phone, tablet, personal digital assistant, a networked server or any other similar device.

The computer software may be stored on a hard drive, or other local storage devices (not shown) such as a solid state drive, magnetic tape or optical storage. Additionally, parts of the computer system may be located remotely. For example, the computer software for programming the computing system may be remotely stored in remote storage device and accessed over a network. The network may be a local network, a wide area network, a virtual private network, the internet or any combination of linked devices. For example, the computing system may be on a local network connected to the internet connected to another local network connected to the remote storage device. The network has elements that are controlled by the operator (or the processor), but may connect to other elements that are not controllable by the operator (or the processor). For example, the network displays several webpages that the operator may change the content of, the links between the pages or the number of pages, and the network may also connect to the Internet which the operator does not control.

The processor 103 is any computer processor capable of executing computer software. The processor does not refer specifically to a central processing unit, but may also refer to combinations of central processing units and graphics processing units or other combinations of electronic devices capable of processing information according to instructions provided by computer software. Additionally, the computing system need not be connected to the internet, but may be entirely self contained in a local system or network. For example, the computer system could be distributed across a network of traffic lights each light containing a small processor optionally attached to one or more central processors with processor 103 standing in for the distributed computing power of all the processors.

The input device 100 inputs information into the computing system from the operator (not shown) or from other sources (such as inputs provided over the network). The input device 100 could be a mouse and keyboard, data port or observation and processing hardware or various combinations of such devices. Furthermore, the input device 100 may be a mouse, a keyboard, voice control, gesture or image recognition or any other device capable of inputting information to the computer system. In a network optimization example concerning traffic throughout a city the input device 100 could include a mouse and keyboard allowing operator input and weight sensors and traffic cameras showing the location of cars. In a website optimization setting the input device 100 could include data collection about visitor mouse location, visitor duration on various webpages included in the website or phrases searched by the visitor that lead the visitor to the website.

The output device 101 outputs information from the computing system to the operator. The input device 100 and the output device 101 may be the same device. For example, a touchscreen monitor may be the input device 100 and the output device 101, as the touchscreen monitor is capable of displaying and receiving information. The output device 101 may be a computer screen, phone screen, monitor, television, printer, traffic signal or any other device capable of outputting information from the computer system. For example, the output device 101 could include traffic lights signaling cars, walk signs signaling safe pedestrian crossing times and hard-drive storage of all output signals and past decision advice. In another example, the output device 101 could include a server displaying a website on the Internet to visitors.

The disclosed system and method can be stored or provided as computer software to the operator on a variety of computer-readable media, such as hard drives, solid state drives, optical discs, or any other computer-readable medium capable of storing instructions for the processor. The disclosed system may also be provided as a built in apparatus requiring no day to day operator interaction. Additionally, the disclosed system and method may be transmitted electronically to the operator over the network.

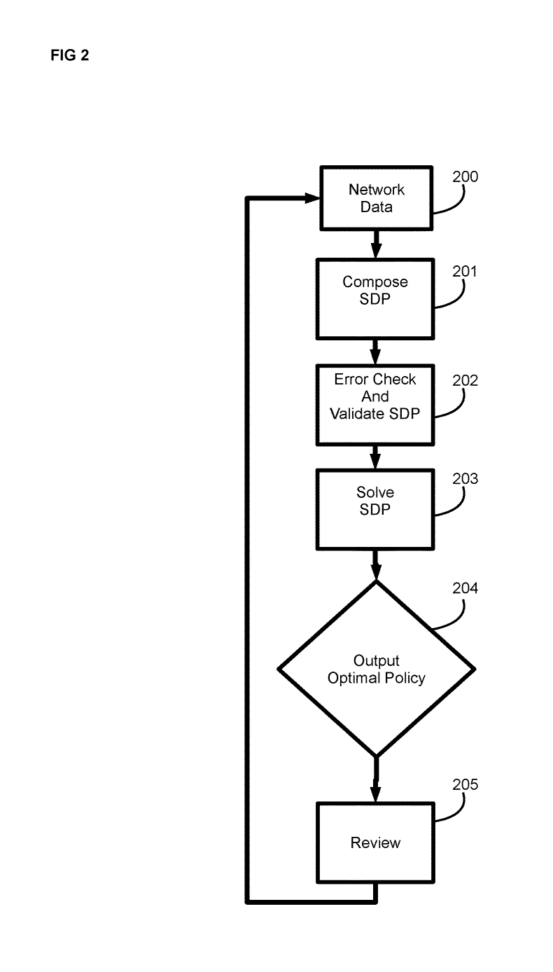

FIG. 2. shows a flowchart of the computer (or computer system as described above) receiving network data in step 200, composing a sequential decision problem in step 201, error checking, validating and convergence checking the sequential decision problem in step 202, solving the sequential decision problem in step 203, outputting the optimal policy in step 204 and providing an opportunity for operator review in step 205 which may lead to re-optimization.

In step 200 the computer receives the network data, which may include a graph of the network and other information relevant to the network and analyzes the provided information to define the elements of a sequential decision problem or series of sequential decision problems), including at least the states, actions, transitions, rewards, and discount factor.

The network data includes a set of nodes and a set of edges, plus a set of probabilities of transitioning from one node to another (intensity information), which may be affected by management decisions of the network operator. The network information may include additional information such as user activities on the network and network operations including purchasing, disengagement, costs and profit margins. The network information may further include funnel information, describing the fraction of users that voluntarily execute commands that transition them to other pages, select products to purchase, request information, purchase, and make payments.

The other information may be sales records, customer information, pricing data or any other information the user knows, or believes to be, relevant to the situation the network the user is attempting to optimize. Additionally, the other information (either with or without the network information) may be statistically analyzed to sort the relevant information from the irrelevant information, and calibrated to minimize computational requirements and provide decision making advice that will most accurately guide the user.

The network data is analyzed to compose a sequential decision problem. A sequential decision problem comprises states, transitions, rewards, actions, a discount factor and time index. The states consist of possible situations in which the subject must make a decision. Each state describes the value of one or more state dimensions, which represent the conditions the subject would like to consider when solving the decision problem to maximize the expected future value. For example, in a network optimization problem states may consist of web pages a customer can be on, as well as conditions of a web page (such as scroll location on a multi-screen page) or information about the customer. In a traffic management problem states may consist of car locations on the overall network of streets or the number of cars at each intersection in a road network.

The transitions represent the probabilities of moving between states when an action is taken. For example, transitions may represent the probabilities of certain outcomes when a driver moves on a street with certain light timings, or a new visitor comes to a web-page with a sale advertisement displayed.

The actions is the set of actions from which the operator selects, at every point in the time index. For example, a user may be able to change light timings in a traffic setting, add new links between pages on a website, or choose content to be displayed on the website. Action costs are the cost to the operator of performing a specific action from the set of actions. At each point in the time index, the operator and network are in a state and the operator selects a specific action, then the operator receives a reward determined by the rewards and the action costs. Additionally, certain actions may cause the computer to generate multiple sequential decision problems, for example when the actions change the state space by adding or eliminating a state. In other cases (based upon the information received in step 200 or operator review in step 205 there may be actions that change other parts of the sequential decision problem, including state, rewards or transition matrices. For example, a certain action may trigger in a specified state changing the decision index from daily to hourly.

The reward represents the benefit received by the user when transitioning between states at a point in the time index after having performed an action. For example, the user adds a new web-page presenting new product information between a home page and a catalog page on a website.

The discount factor represents the time value of money, as well as potentially other subjective criteria. The time index is a set of decision points—discrete moments in time—when the operator takes a specific action from the set of actions. The discount factor takes into account both the risk of considerations related to the timing of rewards and actions. For example the discount factor may represent the operator's preference for immediate over delayed rewards or the operator's assessment of the underlying risk to the subject embedded in the decision problem. The use of such a factor is sometimes considered as converting future potential rewards to their “present value” rewards.

In steps 201 the computer composes the sequential decision problem. The computer system processes the elements from the network data to compose a sequential decision problem by defining a functional equation (or series of functional equations). The functional equation is an equation that may be solved to maximize the value to the operator for a decision problem in all states. The operator may be prompted to select a solution technique, or a default solution technique can be set and used.

In step 202 the computer error-checks, validates and checks for convergence the functional equation to ensure that the functional equation is solvable. These checks confirm that all necessary portions of the problem have been defined through processing the network data.

In step 203 the computer solves the functional equation. Different solution techniques may be used depending on the particular form of the functional equation. Some solution techniques include value function iteration (also known as successive approximations, over-relaxation, or pre-Jacobi iteration), policy iteration (also known as policy improvement), a root-finding algorithm, or other numeric solution techniques. The output is the optimal policy, a mapping of states to a recommended set of actions and the value to the operator in each state.

In step 204 the optimal policy is output. This may mean display for an operator to review or directly implemented by the computer. For example, if the network is a traffic network and the optimal policy contains light timings the computer system may implement the light timings. In another example the network is a series of web sites and the optimal policy may contain decision advice about offering sales or changing links between web sites and the computer may automatically implement the advice. The operator may only implement some of the decision advice or merely review in step 205. In step 205 the operator may review the solution and implement some or all of the solution, change the inputs or allow the network to operate for a period of time.

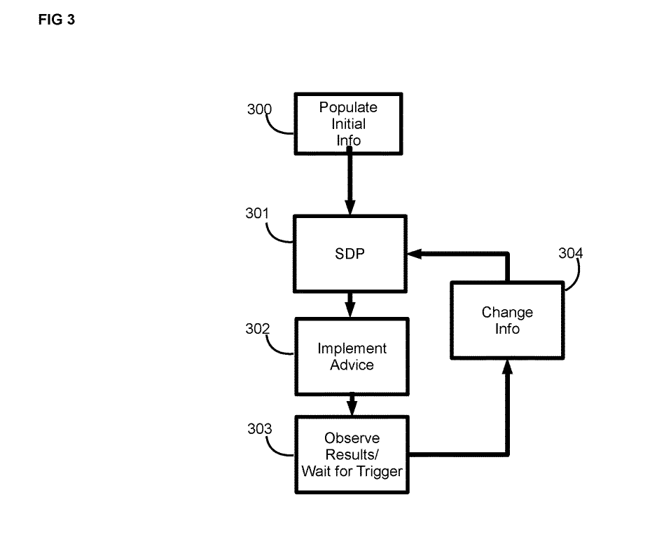

FIG. 3. shows a flowchart of an embodiment where the computer implements the decision advice, observes how the decision advice performs and re-optimizes after a trigger has been reached or upon operator decision. The computer populates initial information in step 300, handles a sequential decision problem in step 301, produces and implements decision making advice in step 302, observes results (potentially including waiting for a trigger to occur) in step 303 and changes the information in step 304.

In step 300 the computer receives or identifies from available inputs the elements of a sequential decision problem as described for step 200. In step 301 the computer performs the functions as described in steps 201, 202 and 203. In step 302 the computer creates decision making advice largely as described in step 204, however in step 302 the computer automatically implements the decision making advice on the network. This may include changing elements of a web-page, offering sales to visitors coming from specific out-of-network locations, changing the links (edges in graph parlance) between pages (nodes), displaying targeted advertising, prompting the operator to completely or nearly completely restructure the network (an expensive and time consuming option) or changes to nodes, edges, node characteristics, actions, or other elements of the sequential decision problem.

In step 303 the computer monitors input, from the network or any other available sources, observing for triggering events and storing data to use in improving the information used in re-optimization. Re-optimization may happen after a pre-set time or event or otherwise automatically re-optimize the network in an ongoing fashion. For example, a traffic network could be set to re-optimize whenever a traffic jam of a certain length is detected at specified locations or social network could be set to prune links between people once a week based upon detection of specified language. this may mean implementation (for example the policy is used to change traffic lights or displayed content of webpages in a website or the links between webpages on a website).

Additionally, re-optimization may happen on a fixed schedule. One important thing to consider is that for many problems many decision points must pass before the monitored information becomes significant enough to change the decision making advice. It may be sub-optimal to re-optimize after every visitor to a website or car passes through a traffic light, instead re-optimization may be set to happen after a relatively large amount of data is collected compared to the initial information. Furthermore the meaning of a relatively large amount of data may change as optimization cycles pass. For example, when optimizing a website re-optimization may be set to occur every time total traffic through the site slows for ten consecutive days or after the site's number of hits has increased by a fixed percentage.

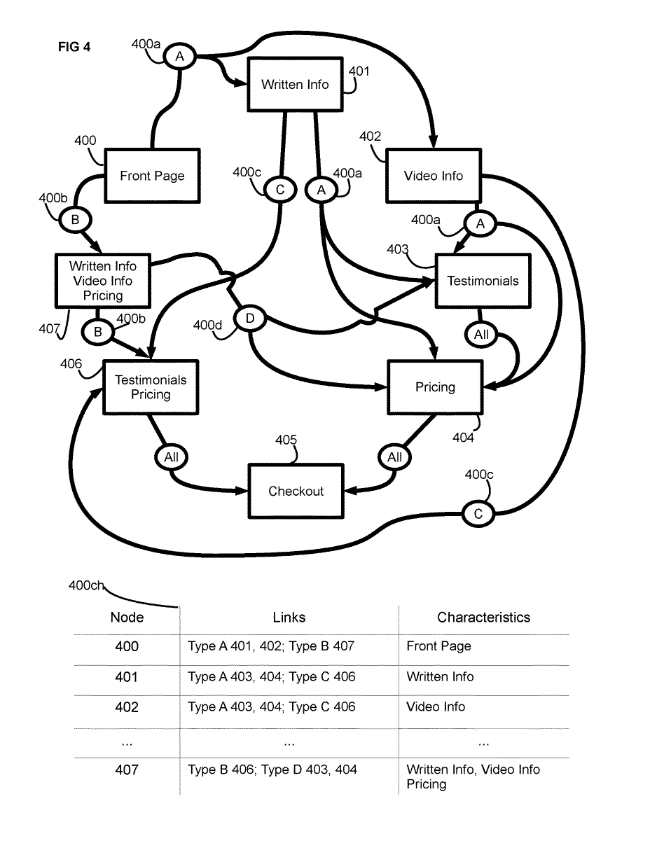

FIG. 4. shows a further embodiment of a highly customized (which can also be thought of as a choose-your-own-adventure) network. In FIG. 4. there are nodes (400, 401, 402, 403, 404, 405, 406 and 407), connected by edges (400a, 400b, 400c, 400d) and the nodes have characteristics displayed in the node and the table 400ch. In this embodiment, the operator changes the content and links visible to the visitor of a website based on information about the visitor. The processor decides to display content from a group of available content (front page, written info, video info, pricing, testimonials and checkout). Additionally, the visitors may be classified according to type, shown in FIG. 4 as types A, B, C and D; and certain links displayed to the visitor depending on the node and the visitor classification. These network nodes may be pages on a website.

In this embodiment, a visitor enters the website at node 400 (with the node characteristic “front page). Depending on the classification of the visitor, based upon information known or available about the visitor, the visitor will observe a link to node 401, or node 407. In FIG. 4 if the visitor to node 400 is classified as type A the visitor will be shown links (shown as 400a) to node 401 and node 402. If the visitor to node 400 is classified as type B the visitor will be shown a link to node 407. If a visitor of type B chooses to clock on the link to node 407, the visitor will observe written information, video information and pricing content. If the visitor on node 407 is classified as type B, the visitor will observe a link to node 406. If the visitor on node 407 is classified as type D, the visitor will observe links to node 403 and node 404. In this embodiment all visitors to node 400 are initially characterized as types A or B, and based upon information learned from the visitor while they are on the site they may be further categorized as type C or D. However, it may also be beneficial to have a (not shown) default network for first time or anonymous visitors, or to have many more links or node characteristics than shown here.

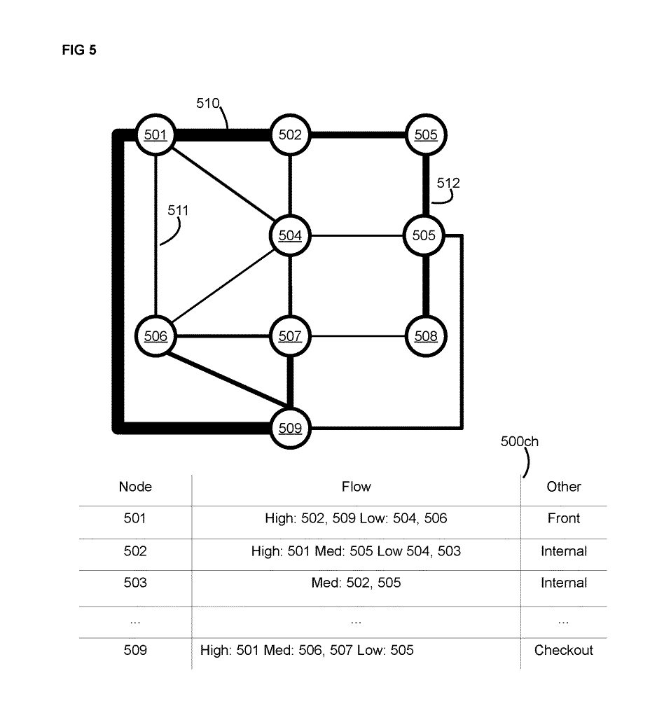

FIG. 5. shows an exemplary embodiment of a graph having nodes 501, 502, 503, 504, 505, 506, 507, 508 and 509, edges 510, 511, 512 (only edges specifically discussed labeled), and a chart 500c showing an alternative embodiment of the information with additional other information (also known as node characteristics) relevant to the network and operator.

FIG. 5. generally, and the nodes specifically, may be viewed as an embodiment showing traffic through a webpage where individual nodes are websites, or it may be viewed as a breakdown of a single or several websites with individual nodes representing elements on the webpages and the edges being derived from heat-map data showing how visitors move between areas on the webpages and websites. Nodes may have characteristics, included as other information. In FIG. 5. this is shown in the chart 500c (column other) with node 501 being defined as the front page, nodes 502 and 503 being internal pages and node 509 being the checkout page. In this sales website embodiment the reward received by the operator may be entirely vested in the checkout node, node 509. In a traffic embodiment the reward may be vested in the exit nodes or distributed throughout the nodes depending on whether the primary concern is throughput through the network or movement within the network.

Edges 510, 511 and 512 have different widths representing throughput, thicker lines showing higher throughput. For example, edge 510 as the thickest line shows the highest level of throughput, edge 510 is connected to node 501 and 502, in FIG. 5. node 501 may represent the landing page of a website, the thick lines emanating from node 501 showing that the majority of visitors first go to the landing page of a website and then move through the website. Some visitors may drop off (for example, by closing the browser, or in a car-traffic problem by entering off-road parking). Other visitors enter directly to a node other than 501. Edges may be used as directed or non-directed, i.e. they may represent only traffic from one to another node, all the traffic between two nodes or some combination or average of the net-traffic between two nodes. The flow column shows one way of tabulating the throughput or flow data also shown as line width.

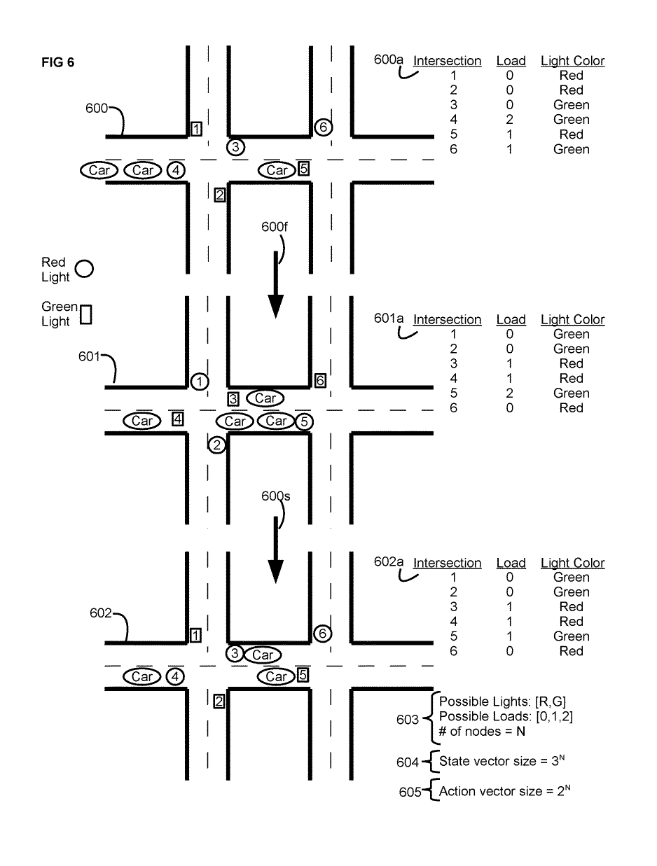

FIG. 6. shows an exemplary embodiment of a traffic network that can be used as network data. FIG. 6 shows three decision points, decision point 600 (the upper-most), decision point 601 (the middle) and decision point 602 (the bottom-most). Arrow 600f shows the first shown action being selected at decision point 600 and the network transition to its state at decision point 601. Arrow 600s shows the second shown action being selected at decision point 601 and the network transition to its state at decision 602. Charts 600a, 601a and 602a show the entrances to the intersections, their loads and the color of the signal lights. Formula 603 shows the relationship between possible lights, possible loads and the number of nodes. Formula 604 shows the relationship between the size of the state vector and number of nodes. Formula 605 shows the relationship between the size of the action vector and the number of nodes.

Enclosed numerals 1 through 6 are nodes, representing entrances to an intersection. Each node defines a dimension of the state vector and a dimension of the action vector. Each state vector element defines the numbers of cars at that node. Each action vector element defines the color of the light at the intersection. The color of the lights is shown by the numeral being enclosed by a circle (red light, for stop) or rectangle (green light, for go). The edges define how one can move from one intersection to the next. For example, from node 4 a transition to node 5 (by going straight) or a transition out of the network (by making a right turn) is possible. A transition directly from node 4 to node 6 is not possible. The agent (who could be the user or someone the user has control over or someone employing the user or otherwise connected to the user) has control over the light colors and allowable transitions. The actions the operator takes change how the car load is distributed after transitions between states.

This embodiment shows merely one way of encoding network information into a sequential decision problem, others are possible. For example, it is possible to analyze a network by considering each state as a total description of the network, but it is also possibly to have each state represent a node with different state dimension representing different node characteristics.

We claim:

1: A computer-aided network control system, comprising an input device, an output device, a network and a processor;
(a) the network having a plurality of nodes and edges, the nodes having at least one characteristic and at least one edge, the characteristics representing information about the corresponding node, the edges representing relationships between nodes;
(b) the input device allowing input of information to the processor;
(c) the output device allowing output of information from the processor;
(d) the processor evaluating a decision problem to provide decision making advice using information from the input device and the processor using the output device to output the decision making advice;
the processor evaluating the decision problem by:
(A) Facilitating input from the input device of information defining the decision problem, the information including;
(i) an action set, the action set having elements representing actions relevant to the network, each element in the action set having a corresponding cost;
(ii) a set of states, which incorporate at least one state dimension,
each state dimension having elements representing conditions relevant to the network, and each state dimension having a corresponding transition matrix representing the probability of moving from each state in the state dimension to each state, for each action in the action set;
(iii) a time index that includes decision points, each decision point representing a point in time when one of the actions from the action set is performed;
(iv) a discount factor, representing a preferential weighting of rewards relative to time;
(v) elements of the set of states that, with elements of the action set, are combined into a reward matrix, the reward matrix mapping each combination of state and action to a reward;
(vi) a set of transition matrices for each state dimension, that are combined to form a total transition matrix;
(vii) the action set having at least one element of the action set representing actions that change at least one of the state dimensions, reward matrix or transition matrices;
(B) Evaluating the functional equation, including error-checking of inputs, validation of inputs and performing an convergence check to ensure the functional equation is solvable;
(C) Forming a functional equation from the set of states, set of actions, reward matrix, total transition matrix, time index, and discount factor;
(D) Solving the functional equation;
(E) Generating decision making advice from the solved functional equation, the decision making advice showing for every state the value-maximizing action;
(F) Outputting the decision making advice through the output device.

2: A computer-aided network control system according to claim 1, wherein the processor receives additional information from the input device as time progresses, and the processor stores the additional information.

3: A computer-aided network control system according to claim 1, wherein the processor implements the decision making advice using the output device for at least one decision point in the time index by taking the appropriate action from the action set according to the decision making advice for the relevant decision point in time.

4: A computer-aided network control system according to claim 1, wherein the processor
(i) receives additional information from the input device as time progresses;
(ii) the processor stores the additional information;
(iii) the processor implements the decision making advice using the output device for at least one decision point in the time index by taking the appropriate action from the action set according to the decision making advice for the relevant decision point in time;
(iv) the processor re-optimizes the decision making advice using the additional information to modify the information used to form the functional equation, the processor forms and evaluates the functional equation and generates new decision making advice;
(v) the processor implements the new decision making advice using the output device for at least one decision point in the time index by taking the appropriate action from the action set according to the decision making advice for the relevant decision point in time;
and
(vi) the processor continues to receive and store additional information and re-optimize and implement the new decision making advice for at least one of the future in time decision points.

5: A computer-aided network control system according to claim 4, wherein the processor re-optimizes the decision making advice when a trigger occurs, the trigger being selected from the group consisting of
(i) a duration event occurs, the duration event representing a period of time received in the information for triggering re-optimization,
(ii) a re-optimization event occurs, the re-optimization event representing at least one specified combination of state dimensions received in the information as triggering re-optimization,
(iii) an error event occurs, the error event representing divergence between additional information received as time progress and the decision making advice that triggers re-optimization,
(iv) a specified decision point has occurred, the specific decision point representing a decision point received in the information as triggering re-optimization,
or (v) a time event occurs; the time event representing a specific time in the time index, received in the information, for triggering re-optimization.

6: A computer-aided network control system according to claim 4, wherein
(a) the input information includes a network of websites viewable by a visitor, the network having a plurality of pages and links, at least one page having at least one characteristic and every page having at least one link, the characteristics representing information about the corresponding page, the links representing paths between pages the visitor can select;
(b) at least one of the actions in the action set is selected from the group consisting of changing at least one link, changing at least some part of one characteristic, re-designing substantially all of the websites, adding at least one page, removing at least one page or changing advertising of at least one part of the network.

7: A computer-aided network control system according to claim 5, wherein
(a) the input information includes a network of websites viewable by a visitor, the network having a plurality of pages and links, at least one page having at least one characteristic and every page having at least one link, the characteristics representing information about the corresponding page, the links representing paths between pages the visitor can select;
(b) at least one of the actions in the action set is selected from the group consisting of changing at least one link, changing at least some part of one characteristic, re-designing substantially all of the websites, adding at least one page, removing at least one page or changing advertising of at least one part of the network.

8: A computer-aided network system according to claim 4; wherein
(a) the input information includes a traffic system transversable by visitors, the traffic system having a plurality of intersections and roads;
(b) the intersections represented as state dimensions containing the number of visitors at each intersection and at least one intersection having a controllable signal capable of indicating to visitors when to move;
(c) the roads represented as transition probabilities between intersections;
(d) the set of actions including actions changing the at least one controllable signal.

9: A computer-aided network system according to claim 5; wherein
(a) the input information includes a traffic system transversable by visitors, the traffic system having a plurality of intersections and roads;
(b) the intersections represented as state dimensions containing the number of visitors at each intersection and at least one intersection having a controllable signal capable of indicating to visitors when to move;
(c) the roads represented as transition probabilities between intersections;
(d) the set of actions including actions changing the at least one controllable signal.

10: A computer-implemented method, comprising the steps of providing a computer system with an input device, an output device, a network and a processor;
(a) the network having a plurality of nodes and edges, the nodes having at least one characteristic and at least one edge, the characteristics representing information about the corresponding node, the edges representing relationships between nodes;
(b) the input device allowing input of information to the processor;
(c) the output device allowing output of information from the processor;
(d) the processor evaluating a decision problem to provide decision making advice using information from the input device and the processor using the output device to output the decision making advice;
the processor evaluating the decision problem by:
(A) Facilitating input from the input device of information defining the decision problem, the information including;
(i) an action set, the action set having elements representing actions relevant to the network, each element in the action set having a corresponding cost;
(ii) a set of states, which incorporate at least one state dimension,
each state dimension having elements representing conditions relevant to the network, and each state dimension having a corresponding transition matrix representing the probability of moving from each state in the state dimension to each state, for each action in the action set;
(iii) a time index that includes decision points, each decision point representing a point in time when one of the actions from the action set is performed;
(iv) a discount factor, representing a preferential weighting of rewards relative to time;
(v) elements of the set of states that, with elements of the action set, are combined into a reward matrix, the reward matrix mapping each combination of state and action to a reward;
(vi) a set of transition matrices for each state dimension, that are combined to form a total transition matrix;
(vii) the action set having at least one element of the action set representing actions that change at least one of the state dimensions, reward matrix or transition matrices;
(B) Evaluating the functional equation, including error-checking of inputs, validation of inputs and performing an convergence check to ensure the functional equation is solvable;
(C) Forming a functional equation from the set of states, set of actions, reward matrix, total transition matrix, time index, and discount factor;
(D) Solving the functional equation;
(E) Generating decision making advice from the solved functional equation, the decision making advice showing for every state the value-maximizing action;
(F) Outputting the decision making advice through the output device.

11: A computer-implemented method according to claim 8, wherein there is an additional step of the processor receiving additional information from the input device as time progresses, and the processor stores the additional information.

12: A computer-implemented method according to claim 8, wherein the step of outputting the decision making advice includes the processor implementing the decision making advice using the output device for at least one decision point in the time index by taking the appropriate action from the action set according to the decision making advice for the relevant decision point in time.

13: A computer-implemented method according to claim 8, wherein during the step of facilitating input the processor (i) receives additional information from the input device as time progresses;
(ii) the processor stores the additional information;
(iii) the processor implements the decision making advice using the output device for at least one decision point in the time index by taking the appropriate action from the action set according to the decision making advice for the relevant decision point in time;
(iv) the processor re-optimizes the decision making advice using the additional information to modify the information used to form the functional equation, the processor forms and evaluates the functional equation and generates new decision making advice;
(v) the processor implements the new decision making advice using the output device for at least one decision point in the time index by taking the appropriate action from the action set according to the decision making advice for the relevant decision point in time;
and
(vi) the processor continues to receive and store additional information and re-optimize and implement the new decision making advice for at least one of the future in time decision points.

14: A computer-implemented method according to claim 13, wherein after the step of outputting the decision making advice the processor re-optimizes the decision making advice when a trigger occurs, the trigger being selected from the group consisting of
(i) a duration event occurs, the duration event representing a period of time received in the information for triggering re-optimization,
(ii) a re-optimization event occurs, the re-optimization event representing at least one sped fled combination of state dimensions received in the information as triggering re-optimization,
(iii) an error event occurs, the error event representing divergence between additional information received as time progress and the decision making advice that triggers re-optimization,
(iv) a specified decision point has occurred, the specific decision point representing a decision point received in the information as triggering re-optimization,
or (v) a time event occurs; the time event representing a specific time in the time index, received in the information, for triggering re-optimization.

15: A computer-implemented method according to claim 13, wherein during the step of facilitating input the processor receives (a) the input information includes a network of websites viewable by a visitor, the network having a plurality of pages and links, at least one page having at least one characteristic and every page having at least one link, the characteristics representing information about the corresponding page, the links representing paths between pages the visitor can select;
(b) at least one of the actions in the action set is selected from the group consisting of changing at least one link, changing at least some part of one characteristic, re-designing substantially all of the websites, adding at least one page, removing at least one page or changing advertising of at least one part of the network.

16: A computer-implemented method according to claim 14, wherein during the step of facilitating input the processor receives (a) the input information includes a network of websites viewable by a visitor, the network having a plurality of pages and links, at least one page having at least one characteristic and every page having at least one link, the characteristics representing information about the corresponding page, the links representing paths between pages the visitor can select;
(b) at least one of the actions in the action set is selected from the group consisting of changing at least one link, changing at least some part of one characteristic, re-designing substantially all of the websites, adding at least one page, removing at least one page or changing advertising of at least one part of the network.

17: A computer-implemented method according to claim 13, wherein during the step of facilitating input the processor receives (a) the input information includes a traffic system transversable by visitors, the traffic system having a plurality of intersections and roads;
(b) the intersections represented as state dimensions containing the number of visitors at each intersection and at least one intersection having a controllable signal capable of indicating to visitors when to move;
(c) the roads represented as transition probabilities between intersections;
(d) the set of actions including actions changing the at least one controllable signal.

18: A computer-implemented method according to claim 14, wherein during the step of facilitating input the processor receives (a) the input information includes a traffic system transversable by visitors, the traffic system having a plurality of intersections and roads;
(b) the intersections represented as state dimensions containing the number of visitors at each intersection and at least one intersection having a controllable signal capable of indicating to visitors when to move;
(c) the roads represented as transition probabilities between intersections;
(d) the set of actions including actions changing the at least one controllable signal.

19: A traffic network control machine, comprising a traffic network, a monitoring device, a control device and a processor;
(a) the traffic network allowing visitors to enter the traffic network, move within the traffic network and exit the traffic network, and the traffic network having (i) at least one changeable signal device, the changeable signal device having variable output indicating travel instructions to travelers near that changeable signal device, (ii) at least one road and (iii) at least one intersection;
(b) the monitoring device allowing input of information to the processor and capable of monitoring traffic conditions on the traffic network;
(c) the control device allowing output of information from the processor and the control device capable of changing the changeable signaling device's output;
(d) the processor evaluating a decision problem concerning the traffic network to provide decision making advice, using information from the monitoring device and the processor using the decision making advice with the control device to control the traffic network through the at least one changeable signaling device; the processor evaluating the decision problem by:
(A) Facilitating input from the monitoring device of information defining the decision problem, the information including;
(i) an action set, the action set having elements representing actions relevant to the traffic network, each element in the action set having a corresponding cost, at least one action in the action set allowing the control device to change the changeable signaling device's output;
(ii) a set of states, which incorporate at least one state dimension,
each state dimension having elements representing conditions relevant to the traffic network, and each state dimension having a corresponding transition matrix representing the probability of moving from each state in the state dimension to each state, for each action in the action set, and the at least one intersection represent as one of the state dimensions containing the number of visitors at each intersection;
(iii) a time index that includes decision points, each decision point representing a point in time when one of the actions from the action set is performed;
(iv) a discount factor, representing a preferential weighting of rewards relative to time;
(v) elements of the set of states that, with elements of the action set, are combined into a reward matrix, the reward matrix mapping each combination of state and action to a reward;
(vi) a set of transition matrices for each state dimension, that are combined to form a total transition matrix;
(vii) the action set having at least one element of the action set representing actions that change at least one of the state dimensions, reward matrix or transition matrices;
(B) Evaluating the functional equation, including error-checking of inputs, validation of inputs and performing an convergence check to ensure the functional equation is solvable;
(C) Forming a functional equation from the set of states, set of actions, reward matrix, total transition matrix, time index, and discount factor;
(D) Solving the functional equation;
(E) Generating decision making advice from the solved functional equation, the decision making advice showing for every state the value-maximizing action;
(F) Implementing the decision making advice through the control device;
(G) Receiving additional information from the monitoring device as time progresses;
(ii) the processor stores the additional information;
(iii) the processor implements the decision making advice using the control device for at least one decision point in the time index by taking the appropriate action from the action set according to the decision making advice for the relevant decision point in time;
(iv) the processor re-optimizes the decision making advice using the additional information to modify the information used to form the functional equation, the processor forms and evaluates the functional equation and generates new decision making advice;
(v) the processor implements the new decision making advice using the control device for at least one decision point in the time index by taking the appropriate action from the action set according to the decision making advice for the relevant decision point in time;
and
(vi) the processor continues to receive and store additional information and re-optimize and implement the new decision making advice for at least one of the future in time decision points;
(H) Re-optimizng the decision making advice when a trigger occurs, the trigger being selected from the group consisting of
(i) a duration event occurs,
(ii) a re-optimization event occurs,
(iii) an error event occurs,
(iv) a specified decision point has occurred,
(v) or a time event occurs; and
(b) (i) the duration event representing a period of time received in the information for triggering re-optimization,
(ii) the re-optimization event representing at least one specified combination of state dimensions received in the information as triggering re-optimization,
(iii) the error event representing divergence between additional information received as time progress and the decision making advice,
(iv) the specific decision point representing a decision point received in the information as triggering re-optimization,
and (v) the time event representing a specific time in the time index, received in the information, for triggering re-optimization.
